(19) United States
(12) Patent Application Publication
(10) Pub. No.: US 2021/0182566 A1
(43) Pub. Date: Jun. 17, 2021

(54) IMAGE PRE-PROCESSING METHOD, APPARATUS, AND COMPUTER PROGRAM

(71) Applicant: ODD CONCEPTS INC., Seoul (KR)

(72) Inventor: Tae Young JUNG, Seoul (KR)

(21) Appl. No.: 16/769,237

(22) PCT Filed: Jan. 17, 2019
(86) PCT No.: PCT/KR2019/000676

§ 371 Date: Jun. 2, 2020

(30) Foreign Application Priority Data
Jan. 17, 2018 (KR) 10-2018-0005820

(51) Int. Cl. G06K 9/00; G06F 16/783

(52) U.S. Cl. CPC G06K 9/00744; G06F 16/7837; G06K 9/00765; G06K 9/00758; G06F 16/785

(57) ABSTRACT

The present invention relates to an image pre-processing method, apparatus, and computer program. The present invention relates to a method for processing an arbitrary image, comprising the steps of: dividing the image into scene units including one or more frames; selecting a frame to be searched according to a preset criterion from the scene; identifying an object associated with a preset subject from the frame to be searched; and searching for image corresponding to the object and/or object information and mapping the search result to the object. According to the present invention, the efficiency of an object-based image search can be maximized and resources to be used for image processing can be minimized.

### TECHNICAL FIELD

The present disclosure relates to a method, apparatus and computer program for preprocessing a video, and more particularly to a method, apparatus and computer program for preprocessing a video to facilitate searching for an object included in the video.

### BACKGROUND ART

As the demand for multimedia services, such as images and videos, increases and portable multimedia devices have come to be widely used, there is increasing need for an efficient multimedia search system that manages a large amount of multimedia data and quickly and accurately finds and provides content desired by a consumer.

Conventionally, in a service providing information about products similar to a product object included in a video, a method in which an administrator separately defines a product object in a video and provides a video including the same is more commonly used than a method of conducting an image search. This method has limited ability to meet consumer need in that it is possible to ascertain similar products only for objects designated by the administrator among objects included in a specific video.

However, there is a problem in that data throughput is too large to conduct a search for each of product objects included in a video. Also, since a video includes one or more frames (images) and each frame includes a plurality of objects, there is a problem as to which object among a large number of objects is to be defined as a query image.

As technology for identifying an object included in a video, there is Korean Patent Laid-Open Publication No 10-2008-0078217 (titled “Method for indexing an object included in a video, additional service method using indexing information thereof, and video processing apparatus thereof”, published on Aug. 27, 2008). The above prior art provides a method that enables a viewer to accurately determine an object present at a designated position on a display apparatus by managing a virtual frame and cell for managing and storing relative positions of objects included in a video for recognition of an object included in a specific video.

However, the above prior art merely discloses a method for identifying an object, and the issue of reducing the amount of resources required for video processing in order to more efficiently conduct a search is not considered therein. Therefore, there is a need for a method capable of minimizing the amount of resources required for video processing and improving search accuracy and efficiency.

### DETAILED DESCRIPTION OF THE INVENTION

### Technical Problem

Therefore, the present disclosure has been made in view of the above-mentioned problems, and an aspect of the present disclosure is to quickly and accurately identify an object for which a search is required among objects included in a video.

Another aspect of the present disclosure is to provide a video processing method capable of maximizing the efficiency of object-based image search and minimizing the amount of resources used for video processing.

Yet another aspect of the present disclosure is to accurately provide information required by a consumer viewing a video and to process a video such that user-oriented information, rather than video provider-oriented information, is provided.

### Technical Solution

In view of the foregoing aspects, a method for processing a video according to the present disclosure includes: dividing the video based on a scene including at least one frame; selecting a search target frame according to a preset criterion in the scene; identifying an object related to a preset subject in the search target frame; and searching for at least one of an image or object information corresponding to the object and mapping search results to the object.

### Advantageous Effects

As described above, according to the present disclosure, it is possible to quickly and accurately identify an object for which a search is required among objects included in a video.

Further, according to the present disclosure, it is possible to maximize the efficiency of object-based image search and to minimize the amount of resources used for video processing.

Further, according to the present disclosure, it is possible to accurately provide information required by a consumer viewing a video and to provide not video provider-oriented information but user-oriented information.

### BRIEF DESCRIPTION OF THE DRAWINGS

FIG. 1 is a block diagram illustrating an object information providing apparatus according to an embodiment of the present disclosure;

FIG. 2 is a flowchart illustrating an object information providing method according to an embodiment of the present disclosure;

FIG. 3 is a flowchart illustrating a video processing method according to an embodiment of the present disclosure;

FIG. 4 to FIG. 8 are flowcharts illustrating a method for dividing a video based on a scene according to an embodiment of the present disclosure;

FIG. 9 is a flowchart illustrating a search target frame selection method according to an embodiment of the present disclosure;

FIG. 10 is a flowchart illustrating a search target frame selection method according to another embodiment of the present disclosure; and

FIG. 11 is a view illustrating an object identified in a video according to an embodiment of the present disclosure.

### MODE FOR CARRYING OUT THE INVENTION

The foregoing objects, features and advantages will be described in detail with reference to the accompanying drawings, and accordingly, those skilled in the art to which this disclosure pertains may easily implement the technical spirit of the present disclosure. In describing the present disclosure, when it is deemed that a detailed description of well-known technologies related to the present disclosure would cause ambiguous interpretation of the present disclosure, such description will be omitted. Hereinafter, exemplary embodiments of the present disclosure will be described in detail with reference to the accompanying drawings, wherein like reference numerals refer to like elements. Any combinations stated in the specification and the claims may be combined using any methods. Further, unless specified otherwise, it should be understood that singular forms may include the meaning of “at least one” and that singular expressions may include plural expressions as well.

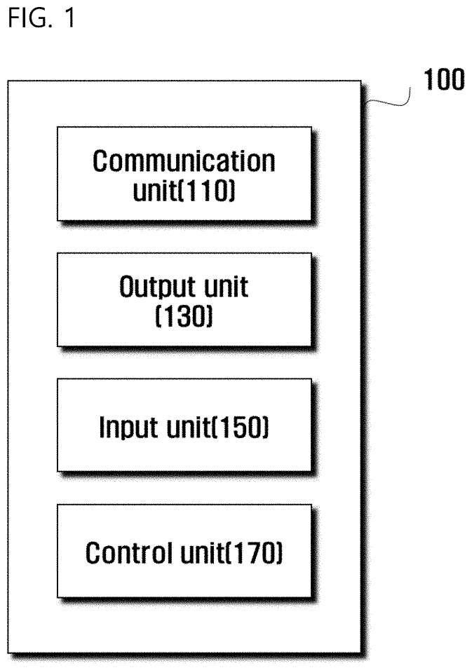

FIG. 1 is a block diagram illustrating an object information providing apparatus according to an embodiment of the present disclosure. Referring to FIG. 1, an object information providing apparatus 100 according to the embodiment of the present disclosure includes a communication unit 110, an output unit 130, an input unit 150, and a control unit 170.

The object information providing apparatus 100 may be a portable terminal, such as a computer, a laptop computer, a tablet, or a smartphone. Further, the object information providing apparatus 100 refers to a terminal to receive data from a server over a wired/wireless network and to control, manage or output the received data in response to user input, and may be implemented in the form of an artificial intelligence (AI) speaker or a set-top box.

The communication unit 110 may receive, from the server, a video processed using a video processing method according to an embodiment of the present disclosure.

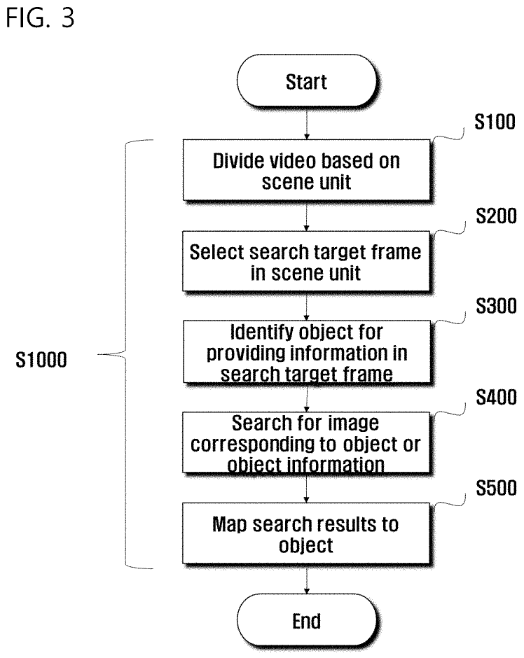

The output unit 130 may output, to a display module (not shown), a video processed using the video processing method according to the embodiment of the present disclosure. The video output from the output unit 130 may be one received from the communication unit 110, or may be one stored in advance in a database (not shown). When video processing according to an embodiment of the present disclosure is performed in the object information providing apparatus 100, the output unit 130 may receive and output the processed video from a video processing apparatus. A further description relating to the video processing method according to the embodiment of the present disclosure is described below with reference to FIGS. 3 to 11. Information on objects included in the video is mapped to the video processed according to the embodiment of the present disclosure. Here, the output unit 130 may display object information together while playing back the video according to a user setting, and may also display the mapped object information when user input is received while playing back an original video. The output unit 130 edits and manages a video to be transmitted to the display module. Hereinafter, an embodiment in the case of displaying object information when user input is received is described.

The input unit 150 receives a preset selection command from a user. The input unit 150 is configured to receive information from the user, and The input unit 150 may include a mechanical input device (or a mechanical key, e.g., a button, a dome switch, a jog wheel, a jog switch, etc., located at front/rear or side of a mobile terminal) and a touch-type input device. For example, the touch-type input device may include a virtual key, a soft key or a visual key displayed on a touchscreen through software processing, or may include a touch key arranged on a part other than the touchscreen. In the meantime, the virtual key or the visual key may be displayed on the touchscreen with various shapes, and may be implemented using, for example, graphics, text, an icon, a video or some combinations thereof.

Further, The input unit 150 may be a microphone processing an external sound signal into electrical voice data. When an utterance or a preset voice command activating the object information providing apparatus 100 is input to the microphone, The input unit 150 may determine that a selection command is received. For example, the object information providing apparatus 100 may be set to be activated when the nickname of the object information providing apparatus 100, ‘Terry’, and the utterance ‘Hi, Terry’ is input. In the case of setting an activation utterance as a selection command, when a user's voice ‘Hi, Terry’ is input through The input unit 150 while outputting a video, the control unit 170 may determine that a selection command for capturing a frame of an input time point has been received, and may capture the frame at the corresponding time point.

Further, the input unit 150 may include a camera module. In this case, a preset selection command may be a user gesture recognized through the camera module, and when a preset gesture is recognized through the camera module, the control unit 170 may recognize the recognized gesture as a selection command.

The control unit 170 may acquire a frame at the time point at which the selection command is input in the video, and may identify an object included in the acquired frame. The frame may be a screenshot of the video being displayed on a display apparatus, and may be one of a plurality of frames included in a preset range around the time point at which the selection command is input. In this case, selecting any one of the frames in a predetermined range based on the input time point may be similar to the following search target frame selection method.

When an object is identified in the frame corresponding to a user selection input, the control unit 170 may verify object information mapped to the corresponding object and transmit the verified object information to the output unit 130. The output unit 130 may output the verified object information. Here, the method of performing display through a display apparatus is not particularly limited.

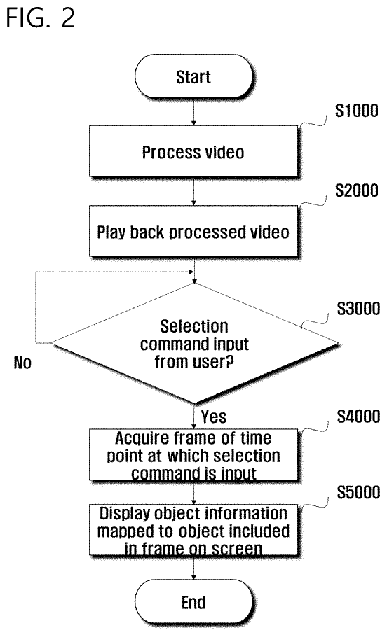

FIG. 2 is a flowchart illustrating an object information providing method of an electronic device according to an embodiment of the present disclosure. Referring to FIG. 2, video processing according to an embodiment of the present disclosure is initially performed (S1000). The video processing may be performed by a server, or may also be performed by an electronic device. When the video processing is performed by the server, the electronic device may receive a processed video from the server and play back the received video. A further description relating to step 1000 is made below with reference to FIG. 3.

The electronic device may play back the processed video (S2000), and may acquire a frame of the time point at which the selection command is input when a preset selection command is input from a user (S4000). Further, the electronic device may display object information mapped to an object included in the frame on a screen (S5000). The object information is included in the processed video, and may be displayed on the screen when a selection command corresponding to a user request is input in step 3000.

In another embodiment, the electronic device may display object information mapped to each object regardless of the selection command from the user while playing back the processed video.

FIG. 3 is a flowchart illustrating a video processing method of an electronic device according to an embodiment of the present disclosure. Hereinafter, for convenience of description, a description is made based on an embodiment in which a server processes a video.

Referring to FIG. 3, in processing a video for providing object information, the server may divide the video based on a scene including at least one frame (S100).

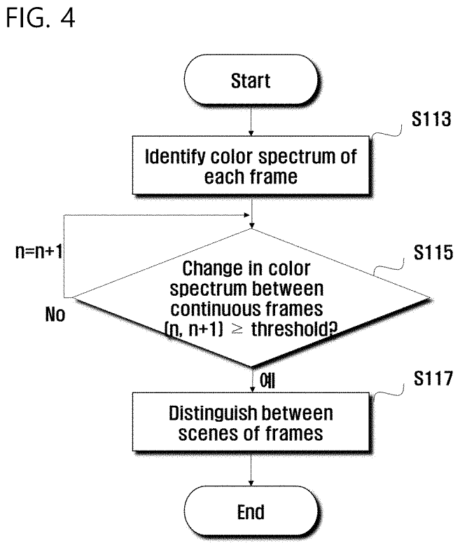

An embodiment of step 100 for dividing a video based on scenes is described with reference to FIG. 4. A scene is a single unit of video related to a similar subject or event, and lexically refers to a single scene of a movie, a drama, or a literary work. In the present specification, a scene unit for dividing a video may also be understood to indicate at least one frame related to a single event or subject. That is, a change of space or character is not abrupt within one scene, and thus an object (except for a moving object) included in the video may be maintained without significant change in the frame. The present disclosure significantly reduces the amount of data to be analyzed by dividing a video based on a scene and selecting only any one frame in a scene and using the selected frame for image analysis.

For example, in the case of tracking an object based on a frame unit, there is a problem in that excessive resources are consumed. In general, a video uses about 20 to 60 frames per second, and the number of frames per second (FPS) is gradually increasing as the performance of electronic devices improves. When 50 frames are used per second, a 10-minute video contains 30,000 frames. Object tracking based on a frame unit means that it is necessary to individually analyze which objects are included in each of 30,000 frames. Therefore, there is a problem in that, when a feature of an object in a frame is analyzed using a machine learning, the amount of processing becomes too large. Therefore, the server may reduce the amount of processing and increase a processing rate by dividing a video into scenes in the following manner.

In step 100, the server may identify the color spectrum of a frame (S113), may determine whether a change in the color spectrum between consecutive first and second frames is greater than or equal to a preset threshold (S115), and may distinguish between scenes of the first frame and the second frame when the change in the color spectrum is greater than or equal to the preset threshold (S117). When there is no change in the color spectrum between two consecutive frames, step 115 of determining may be performed again on the next frame.

In still another embodiment of step 100, the server may detect feature information, estimated as an object in the frame, and may determine whether first feature information included in the first frame is included in the second frame, subsequent thereto. When the first feature information is not included in the second frame, the server may distinguish between the scenes of the first frame and the second frame. That is, the server may set frames in which feature information estimated as an object is included as one scene, and when corresponding feature information is no longer included in a specific frame, may classify frames starting from the specific frame into a different scene. “Detect” is a concept different from “recognize” or “identify”, and may be a task that is one level lower than recognition of identifying an object with the goal of determining the presence or absence of the object in an image. In more detail, detection of feature information estimated as an object may identify an object using a boundary between the object and a background, or may use a global descriptor.

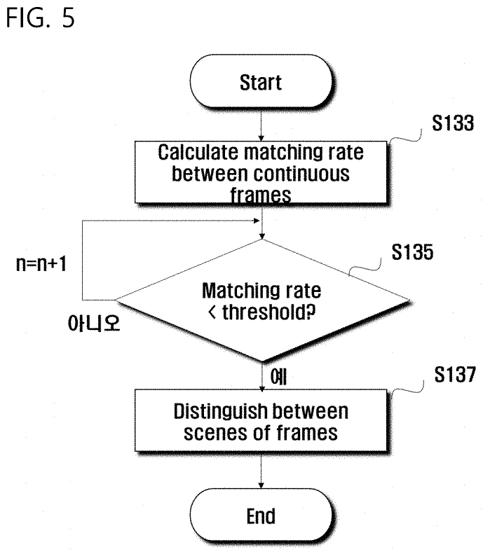

In still another embodiment of step 100, referring to FIG. 5, the server may calculate a matching rate between consecutive first and second frames (S133) and determine whether the matching rate is less than a preset value (S135). The matching rate is an index that represents the degree of image matching between two frames. When a background is repeated or when the same character is included in the frames, the matching rate may increase.

For example, in a video, such as a movie or a drama, a character and a space may match between continuous frames related to an event in which the same character acts in the same space and thus a matching rate may be very high, and accordingly, the above frames may be classified into the same scene. When the matching rate as a result of the determination in step 135 is less than the preset value, the server may distinguish between the scenes of the first frame and the second frame. That is, a change in a space displayed on a video or a change in a character appearing in the video causes a matching rate between continuous frames to significantly decrease. Therefore, in this case, the server may determine that a transition between scenes has occurred and thus distinguish between scenes of the respective frames, and may set the first frame to a first scene and set the second frame to a second scene.

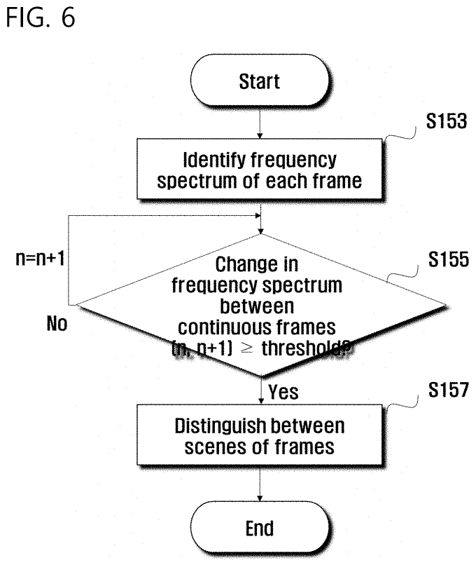

In still another embodiment of step 100, referring to FIG. 6, the server may identify the frequency spectrum of each frame (S153), and when a change in the frequency spectrum between consecutive first and second frames is greater than or equal to a preset threshold (S155), may distinguish between scenes of the first frame and the second frame (S157). In step 153, the server may identify the frequency spectrum of each frame using DCT (Discrete Cosine Transform), DST (Discrete Sine Transform), DFT (Discrete Fourier Transform), MDCT (Modified DCT, Modulated Lapped Transform), and the like. The frequency spectrum represents the distribution of frequency components of an image included in a frame, and may be understood to represent information on an outline of the entire image in a low-frequency domain and to represent information on details of the image in a high-frequency domain. The change in the frequency spectrum in step 155 may be measured by comparing component-by-component magnitudes.

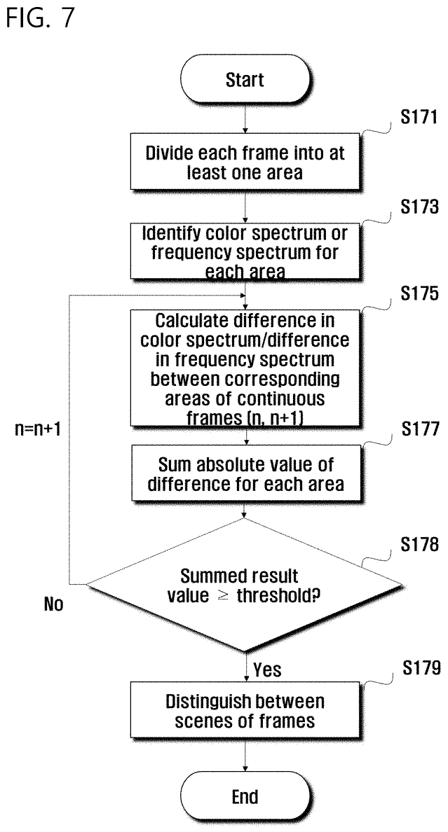

In still another embodiment of step 100, referring to FIG. 7, the server may segment each frame into at least one area of a preset size (S171), and may identify a color spectrum or a frequency spectrum for each area (S173). The server may calculate the difference in the color spectrum or the difference in the frequency spectrum between corresponding areas of consecutive first and second frames (S175), and may sum an absolute value of difference for each area (S177). When the summed result value is greater than or equal to a preset threshold (S178), the server may distinguish between scenes of the first frame and the second frame (S179).

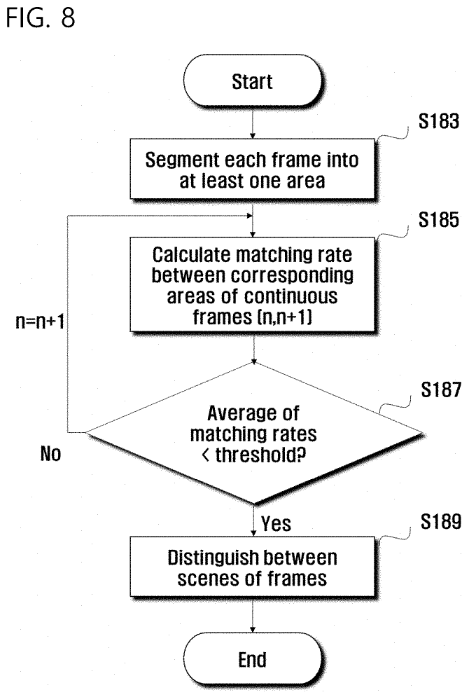

In still another embodiment, as illustrated in FIG. 8, the server may segment each frame into at least one area of a preset size (S183), may calculate a matching rate for the respective corresponding areas of consecutive first and second frames (S185), and when the average of the matching rates is less than a preset value (S187), may distinguish between scenes of the first frame and the second frame (S189).

Similar to the examples described above with reference to FIG. 7 and FIG. 8, in the case of segmenting a frame into at least one area and comparing a front frame and a rear frame for each area, there may be cases where the frames are similar overall, but differ greatly in portions thereof. That is, according to the above-mentioned two embodiments, it is possible to distinguish between scenes in further detail.

In a step following step 100, the server may select a search target frame according to a preset criterion in the scene (S200). In the present specification, “search target frame” may be understood to refer to a frame that includes a target object for which an object-based search is to be conducted. That is, in an embodiment of the present disclosure, the server may reduce the amount of resources by designating a search target frame and analyzing only an object included in the search target frame, instead of tracking and analyzing objects in all of the frames included in a video. The server does not analyze all of the frames, and thus desires to extract the object most likely to increase search accuracy. Therefore, in step 200, the server may select, as the search target frame, a frame capable of providing the most accurate search results when conducting an object-based search.

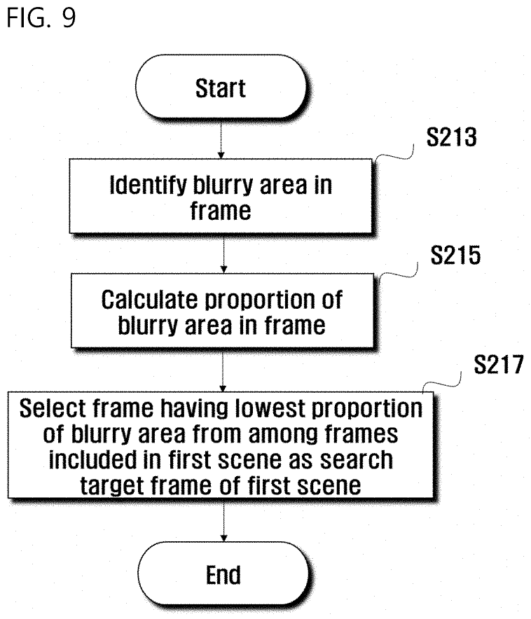

For example, referring to FIG. 9, in selecting the search target frame, the server may identify a blurry area in the frame (S213), and may calculate the proportion of the blurry area in the frame (S215). The server may select the frame having a lowest proportion of the blurry area from among one or more frames included in a first scene as a search target frame of the first scene (S217). The blurry area refers to an area displayed out of focus in the video, and may make it impossible to detect an object, or may degrade the accuracy of object-based image search. A plurality of pixels obscuring objectivity may be mixed in the blurry area, and such pixels may cause an error in detecting or analyzing an object. Therefore, the server may select the frame having the lowest proportion of the blurry area as a search target frame of each scene such that the accuracy of subsequent detection and analysis and object-based image search may be improved.

In an embodiment of the present disclosure, the server may detect a blurry area by identifying, as the blurry area, an area in which a local descriptor is not extracted in a frame. The local descriptor is a feature vector representing a key part of an object image, and can be extracted using various methods, such as SIFT (Scale Invariant Fourier Transform), SURF (Speeded-Up Robust Features), LBP (Local Binary Patterns), BRISK (Binary Robust Invariant Scalable Keypoints), MSER (Maximally Stable External Regions), FREAK (Fast Retina Keypoints), etc. The local descriptor is distinguished from a global descriptor that describes the entire object image, and refers to a concept used in a higher-level application, such as object recognition. In the present specification, the local descriptor is used in the sense commonly used by those skilled in the art.

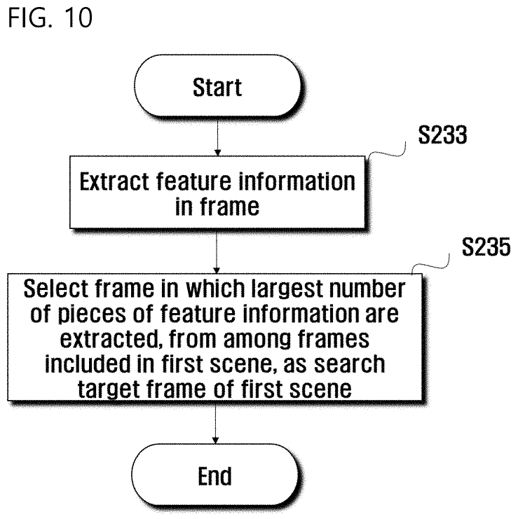

In another embodiment of step 200 of selecting the search target frame, referring to FIG. 10, the server may extract feature information in the frame (S233), and may select the frame in which the largest number of pieces of feature information are extracted, from among one or more frames included in a first frame as a search target frame of the first scene (S235). The feature information is a concept including all of a global descriptor and a local descriptor, and may include a feature point and a feature vector capable of recognizing an outline, a shape and a texture of an object or a specific object.

That is, the server may extract feature information to the level not enough to be capable of recognizing an object, but enough to be capable of detecting the presence of the object, and may designate the frame that includes the largest number of pieces of feature information as a search target. As a result, the server may conduct an object-based image search using the frame that includes the largest number of pieces of information for each scene in step 300, and may minimize the number of omitted objects without extracting objects in all of the frames, and may detect and use an object at a high accuracy.

In step 300, the server may identify an object related to a preset subject in the search target frame. Identification of an object may be performed through an operation of extracting feature information of the object. In this step, the server may identify the object in further detail than in the detection of the object performed in previous steps (S100 and S200). That is, the server may use a more accurate algorithm among object identification algorithms and may extract an object so that there is no missing object in a search target frame.

For example, assuming the case of processing a drama video, the server may classify, into one scene, at least one frame shot in a kitchen in the drama video in step 100 and may select a search target frame according to a preset criterion in step 200.

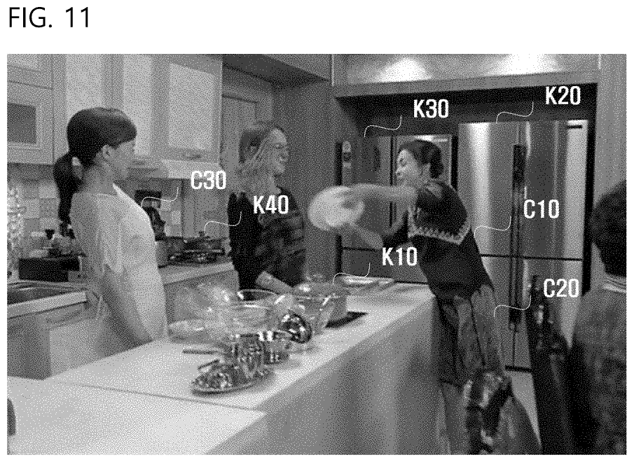

If FIG. 11 corresponds to the search target frame selected in step 200, the frame of FIG. 11 may be selected as the search target frame because the proportion of a blurry area among scenes shot in the kitchen is the lowest, and may also be selected because the number of objects detected in the corresponding scene is the largest. Objects related to kitchen appliances/tools, such as pots (K10, K40), refrigerators (K20, K30), and the like, are included in the search target frame of FIG. 11, and additionally, clothing-related objects, such as a top (C10), a skirt (C20) and a one-piece (C30), are included. In step 300, the server identifies the objects (K10 to K40, C10 to C30) in the search target frame.

Here, the server may identify an object related to a preset subject. As illustrated in FIG. 11, a large number of objects may be detected in the search target frame, and the server may extract only necessary information by identifying an object related to a preset subject. For example, if a preset subject is clothing, the server may identify only objects related to clothing, and in this case may identify the top (C10), the skirt (C20), the one-piece (C30), and the like. If a preset subject relates to kitchen appliances/tools, the server may identify K10, K20, K30, and K40. Here, ‘subject’ refers to a category for classifying objects, and the category that defines an object may be a higher concept or a lower concept according to a user setting. For example, the subject may be set to a higher concept, such as clothing, and may also be set to a lower concept, such as a skirt, a one-piece, and a T-shirt.

The entity that sets the subject may be an administrator who manages the server, or may be a user. When the subject is set by the user, the server may receive information on the subject from a user terminal and may identify an object in a search target frame according to the received subject information.

Next, the server may search for at least one of an image or object information corresponding to the identified object in step 400 and may map search results to the object in step 500. For example, when a clothing-related object is identified, the server may acquire an image corresponding to a top (C10) by searching an image database for an image similar to the identified top (C10). Also, the server may acquire object information related to the top (C10) from the database, that is, object information, such as an advertising image and/or video, price, brand name, and participating online/offline shops selling a top printed with white diagonal stripes on a black background. Here, although the database may be generated in advance and included in the server, the database may be constructed through a real-time search of similar images by scrolling a webpage in real time, and the server may conduct a search using an external database.

Search results, that is, an image corresponding to the identified object, product information (price, brand name, product name, product code, product type, product feature, where to buy, and the like) corresponding to the object, advertising text, an advertising video, an advertising image, and the like, may be mapped to the identified object. Such mapped search results may be displayed on a layer adjacent to the video, or may be displayed in the video or on an upper layer of the video when playing back the video. Alternatively, when playing back the video, search results may be displayed in response to a user request.

Some embodiments omitted in the present specification are equally applicable if an implementation entity thereof is the same. Further, it will be apparent to those skilled in the art to which the present disclosure pertains that various replacements, changes and modifications can be made without departing from the technical spirit of the present disclosure, and such changes are not limited to the foregoing embodiments and accompanying drawings.

1. A method for processing a video, the method comprising:
dividing the video based on a scene comprising at least one frame;
selecting a search target frame according to a preset criterion in the scene;
identifying an object related to a preset subject in the search target frame; and
searching for at least one of an image or object information corresponding to the object and mapping search results to the object.

2. The method as claimed in claim 1, wherein the dividing of the video based on the scene comprises:
identifying a color spectrum of the frame; and
distinguishing between scenes of a first frame and a second frame, which are consecutive, when a change in the color spectrum between the first frame and the second frame is greater than or equal to a preset threshold.

3. The method as claimed in claim 1, wherein the dividing of the video based on the scene comprises:
detecting feature information estimated as an object in the frame;
determining whether first feature information present in a first frame is present in a consecutive second frame; and
distinguishing between the scenes of the first frame and the second frame when the first feature information is not present in the second frame.

4. The method as claimed in claim 1, wherein the dividing of the video based on the scene comprises:
calculating a matching rate between a first frame and a second frame, which are consecutive; and
distinguishing between scenes of the first frame and the second frame when the matching rate is less than a preset value.

5. The method as claimed in claim 1, wherein the dividing of the video based on the scene comprises:
identifying a frequency spectrum of the frame; and
distinguishing between scenes of a first frame and a second frame, which are consecutive, when a change in a frequency spectrum between the first frame and the second frame is greater than or equal to a preset threshold.

6. The method as claimed in claim 1, wherein the dividing of the video based on the scene comprises:
segmenting each frame into at least one area of a preset size;
identifying a color spectrum or a frequency spectrum for each area;
calculating a difference in the color spectrum or a difference in the frequency spectrum between corresponding areas of a first frame and a second frame, which are consecutive;
summing absolute values of differences calculated for each area; and
distinguishing between scenes of the first frame and the second frame when a result of the summing is greater than or equal to a preset threshold.

7. The method as claimed in claim 1, wherein the dividing of the video based on the scene comprises:
segmenting each frame into at least one area of a preset size;
calculating a matching rate of each of corresponding areas of a first frame and a second frame, which are consecutive; and
distinguishing between scenes of the first frame and the second frame when an average of the matching rates is less than a preset value.

8. The method as claimed in claim 1, wherein the selecting of the search target frame comprises:
identifying a blurry area in the frame;
calculating a proportion of the blurry area in the frame; and
selecting a frame having a lowest proportion of the blurry area from among one or more frames comprised in a first scene as a search target frame of the first scene.

9. The method as claimed in claim 8, wherein the identifying of the blurry area comprises identifying, as a blurry area, an area in which a local descriptor is not extracted in the frame.

10. The method as claimed in claim 1, wherein the selecting of the search target frame comprises:
extracting feature information in the frame; and
selecting a frame in which largest pieces of feature information are extracted from among one or more frames comprised in a first scene as a search target frame of the first scene.

11. An object information providing method of an electronic device using the method as claimed in claim 1, the method comprising;
playing back a video processed using the method as claimed in claim 1;
acquiring a frame of a time point at which the selection command is input upon receiving a preset selection command from a user; and
displaying object information mapped to an object comprised in the frame on a screen.

12. An apparatus for providing object information using the method as claimed in claim 1, the apparatus comprising:
an output unit to output a video processed using the method as claimed in claim 1;
an input unit to receive a preset selection command from a user; and
a control unit to acquire a frame of a time point at which the selection command is input in the video and to identify an object comprised in the frame,
wherein the output unit outputs object information mapped to the identified object.

13. A video-processing application stored in a computer-readable medium to execute the method as claimed in claim 1.
